(19) United States
(12) Patent Application Publication
(10) Pub. No.: US 2022/0009285 A1
(43) Pub. Date: Jan. 13, 2022

(54) Non-Pneumatic Structural Bicycle Tire

(71) Applicant: Joseph Iannelli, Glenshaw, PA (US)

(72) Inventor: Joseph Iannelli, Glenshaw, PA (US)

(21) Appl. No.: 16/923,136

(22) Filed: Jul. 8, 2020

(51) Int. Cl. B60C 7/12

(52) U.S. Cl. CPC B60C 7/12; B60C 2200/12

(57) ABSTRACT

The present invention provides a non-pneumatic structural bicycle tire, manufactured from TPU, TPE, other thermoplastics including TPS and TPZs, or other polymers and additives, as well as similar or dissimilar plastic such as PLA, ABS, and or recycled plastic material blend. The tire includes structural members of various sizes, thicknesses and angles, both contouring with the wheel, forming both arches, bridges and angled, voids including Euclidian and non-Euclidian triangles, diamonds, “V” shapes and other voids either with or without similar or dissimilar plastic infill between members in various fill levels and designs. The structural members create cross members and supports for transverse protrusions which compress to varying degrees depending on their specific characteristics. The non-pneumatic structural bicycle tire provides increased comfort, weight reduction, and durability when compared to other pneumatic or non-pneumatic tires.

### FIELD OF THE INVENTION

The present invention relates to non-pneumatic bicycle tires and, in particular, to non-pneumatic bicycle tires manufactured with unique structural members and non-traditional materials.

### BACKGROUND OF THE INVENTION

Bicycling is a common activity worldwide. Bicycle tires are important components establishing limits of performance including durability, shock absorption, and comfort among other attributes. The general concept of non-pneumatic tires is a popular one for achieving a performance measure of puncture resistance or durability, however, oftentimes this comes with compromises in weight and comfort or in other areas of performance. Currently available non-pneumatic tires use cavities, transverse cylindrical holes or other structures. Advances in plastic manufacturing processes allow non-pneumatic tires to be manufactured by methods other than traditional methods.

Considering these possibilities, there exists a need for a new tire construct which achieves satisfying and even improves most or all methods of measuring tire performance by using tires with various internal structural arches, lines, and voids with particular attributes.

### SUMMARY OF THE INVENTION

One object of the present invention is to provide a new form of tire construction utilizing unique transverse voids with varying levels of infill structure, separated and defined by arches and lines.

Another object of the invention is to take advantage of additive manufacturing to include internal structural supports and cavities that are not included in traditional manufacturing processes.

Another object of the invention is to use circumferentially symmetrical, non-unidirectional structures which creates improved bounce.

Another aspect of the invention is to duplicate the comfort of pneumatic tires by using non-unidirectional internal structures and cavities as opposed to non-pneumatic tires which are designed to allow compression in one direction as they roll.

Another object of the invention is to provide non-pneumatic tires that have improved strength to weight characteristics compared to conventional non-pneumatic tires.

Another object of the invention is to provide a non-pneumatic tire that is durable.

Another object of the invention is to provide a non-pneumatic tire that is safer than conventional non-pneumatic tires and that are unaffected by punctures.

Another object of the invention is to use the same manufacturing process and material for the outer treads and inner wheel contacting portion of the tire, although the depicted or described treads and shapes of the wheel which the tires are mounted to are not meant limit in any way the stated characteristics of the invention.

Another object of the invention is to use polymers selected from polymers and composites comprising thermoplastics selected from thermoplastic polyurethane (TPU), thermoplastic elastomer (TPE), thermoplastic styrenic elastomers (TPS) and thermoplastics not classified as elastomers (TPZ); polymers mixed with other compounds and fiber additives comprising carbon; plastics comprising polylactic acid (PLA) or acrylonitrile butadiene styrene (ABS); and recycled plastic material blend. in order to deliver desired properties to the tire.

Another object of the invention uses traditional polymers or recycled plastic blends, or plastic polymers with other materials contained within, such as carbon fiber filaments.

Another embodiment of the invention has no infill so the transverse voids are completely empty.

Another embodiment has some degree of infill so the voids are not completely empty.

Another embodiment has the infill in the second embodiment constructed out of a different or recycled plastic than the primary.

Another embodiment uses thinner or thicker structures and arches. Another embodiment uses members that do not all span from entire height of the tire section of creating structural air gaps and more complex polygonal voids than the specific triangle, diamond, and square voids covered by the invention, such as “V” shaped voids.

Another embodiment uses a “grid” shaped infill.

Another embodiment of the invention uses an outer wall to protect the voids.

Another embodiment involves semi-randomly extruded recycled plastic blend to fill the voids partially and increase their “bounce” characteristics, mimicking higher psi pneumatic tires.

Another embodiment uses coil or spring-like primary or secondary polymers to increase “bounce” and higher psi feeling of the tire.

### BRIEF DESCRIPTION OF THE DRAWINGS

For the present invention to be easily understood and readily practiced, it will now be described for purposes of illustration and not limitation in connection with the following figures, where like reference numerals refer to identical or functionally similar elements throughout the separate views, wherein:

FIG. 1 is a side elevational view of the non-pneumatic structural bicycle tire, in accordance with the embodiments of the invention;

FIG. 2 is an off-center side elevational view to show depth of the non-pneumatic structural bicycle tire, in accordance with the embodiments of the invention;

FIG. 3 is an enlarged partial side elevational view of the non-pneumatic structural bicycle tire, in accordance with the embodiments of the invention;

FIG. 4 is an enlarged partial cross-sectional view taken along line 4-4 of the front non-pneumatic bicycle wheel in FIG. 2 showing internal structures and voids, in accordance with the embodiments of the invention;

FIG. 5 is a sectional view showing internal composition of each structural member and ability to create additional crevices, voids, lines and angles within the structures composing the primary voids and angles, in accordance with the embodiments of the invention.

FIG. 6 is a sectional similar of a core structure of the non-pneumatic structural bicycle tire, in accordance with the embodiments of the invention;

FIG. 7 is a sectional view of the grid infill structure, in accordance with the embodiments of the invention.

FIG. 8 is an enlarged partial side elevational view of the non-pneumatic structural bicycle tire with outer walls concealing triangular interior voids, in accordance with the embodiments of the invention;

FIG. 9 is a cross section of the partial side elevation view taken along line 9-9 of FIG. 8 showing internal simple triangular voids hidden by the outer wall, in accordance with the embodiments of the invention;

FIG. 10 is a sectional similar to showing the cross-sectional view of the embodiments shown in FIG. 8 and FIG. 9 from the front to reveal internal structures and voids; in accordance with the embodiments of the invention;

FIG. 11 is an enlarged partial side elevational view showing a coiled internal structure; in accordance with the embodiments of the invention;

FIG. 12 is perspective view showing the depth and location of the coiled internal structure, in accordance with the embodiments of the invention; and

FIG. 13 is front view showing the infill coil replaced by a premeasured amount of recycled material blend or other plastic composite extruded into the void as the infill material.

### DETAILED DESCRIPTION OF THE INVENTION

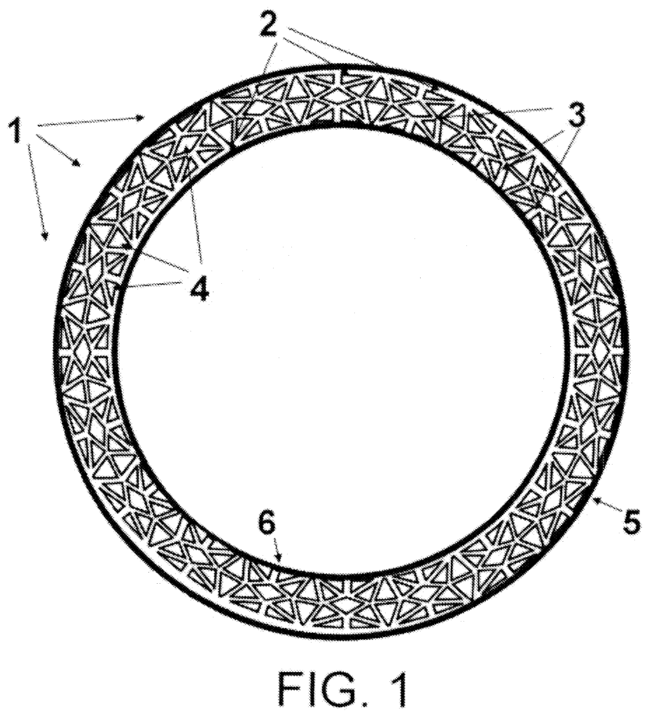

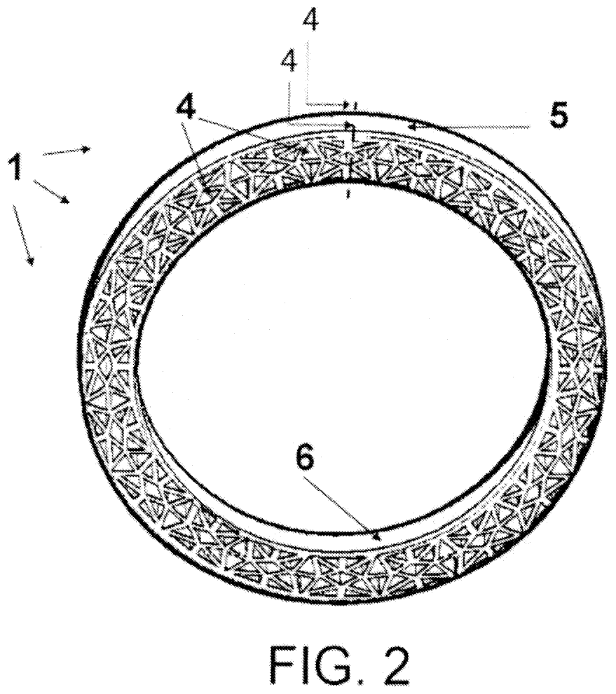

Referring now to the figures, FIG. 1 shows the non-pneumatic structural bicycle tire 1 of the invention. The non-pneumatic structural bicycle tire 1 does not include a preferred tread or rim mount shape or material as it is designed to be used with multiple embodiments of tread, rim mount shape and material. The non-pneumatic structural bicycle tire 1 includes supporting arches 2 and lines 3 meeting at angles to form voids 4. In this embodiment, the voids 4 are shown without infill. Boundaries of the voids 4 are established by the supporting arches 2, lines 3, and angles connecting the inner and outer tire portions. Also shown is an outer tread mount face 5 and an inner rim mount face 6. The inner rim mount face generic treads are not shown intentionally, meant to not limit or restrict the invention in any way. The inner rim mount face 6 is located where the inner portion of the tire connects to a wheel. FIG. 2 is a slightly tilted view to better show the depth of the structural bicycle tire 1 as well as to give a clearer view of the outer tread mount face 5, the inner rim mount face 6, as well as the depth of the voids 4.

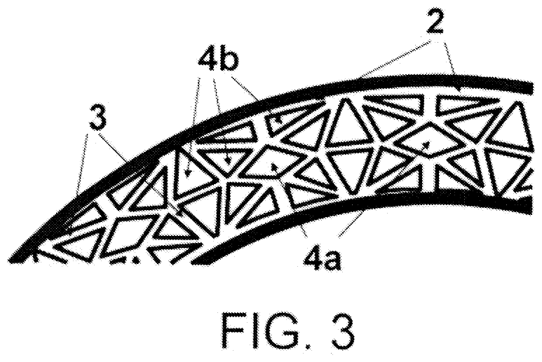

FIG. 3 is an enlarged sectional of the non-pneumatic structural bicycle tire 1 of the invention. Some of the individual lines that make up structural supports include support arches 2 necessary to maintain the circular feature of a tire. The support arches 2, along with the lines 3 create diamond void 4a patterns 4a and triangular 4b void patterns, both of which are specific embodiments of the voids 4.

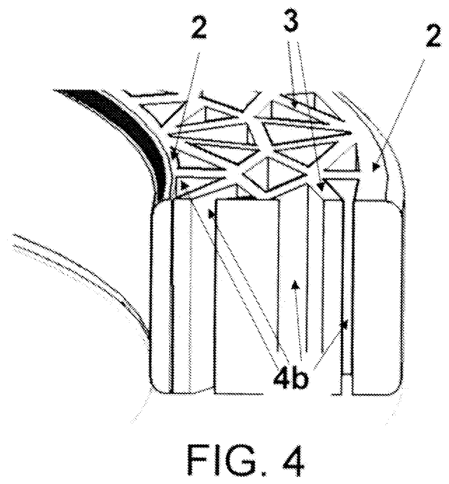

FIG. 4 is a cross-sectional view of the front of the non-pneumatic structural bicycle tire, showing the inside of the tire from the upper to the lower layers. As you progress from one end to the other, void patterns and structures change. This cross-section view shows the middle of several voids created by several structural lines 3 and support arches 2, which inside cut shows four separate triangular voids 4b.

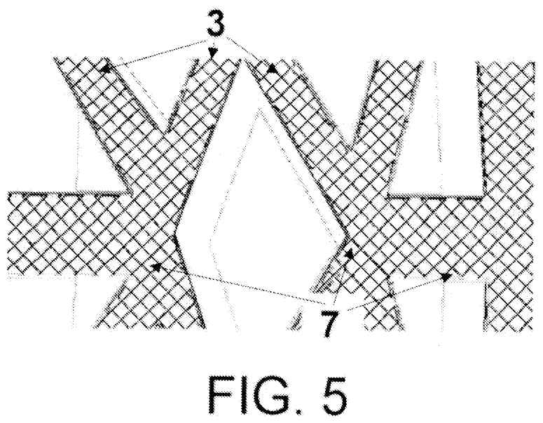

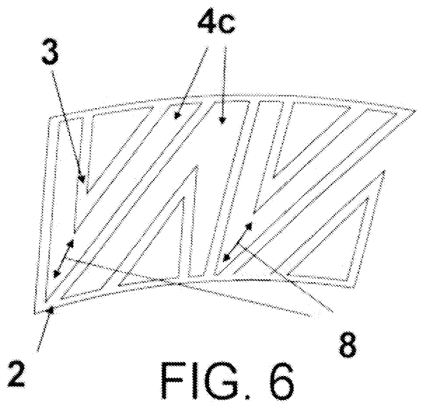

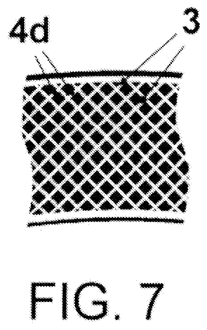

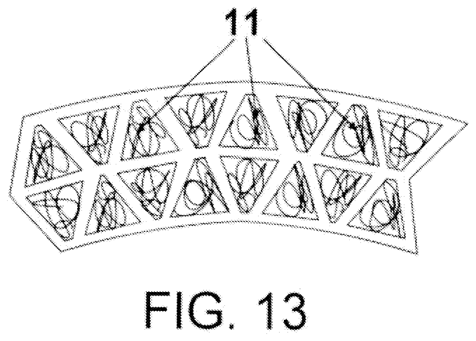

FIG. 5 shows the non-pneumatic structural bicycle tire having internal voids 7 and lines 3 contained within the internal structure of the structural arches 2 and lines 3 (shown in FIGS. 1-4), which allows further weight reduction compared to a prior art injection molded tire. As shown in FIG. 6, this embodiment shows that the non-pneumatic structural bicycle tire of the invention is not limited to any particular pattern, as this embodiment includes “V” shaped voids 4c and structural air gaps 8, which allowing the tire to maintain the comfort of a low psi tire while reaching a maximum point under pressure in which the lines 3 and arches 2 touch, thus restricting further compression. In addition, recycled infill 11 (shown in FIG. 13) also can be used to add performance characteristics of a higher psi non-pneumatic tire than what would be expected from this embodiment. In an embodiment, as shown in FIG. 7, even-spaced lines 3 are used to create square-shaped voids 4d.

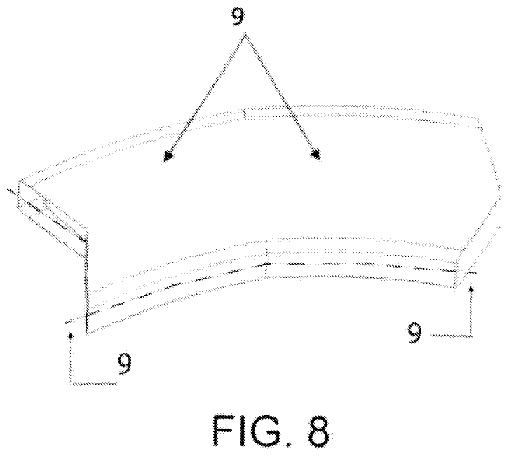

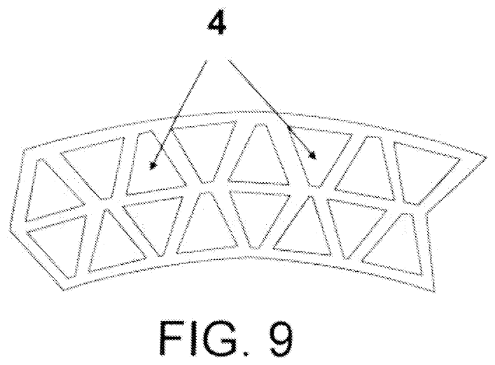

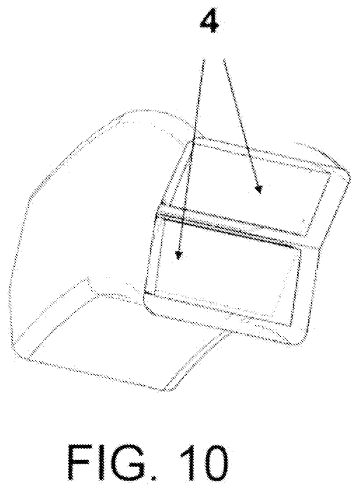

As shown in FIG. 8, the non-pneumatic structural bicycle tire includes an outer wall 9 which protects and conceals the internal voids of the tire. The outer wall 9 can be used in combination with any other protective structure to protect the voids 4 from environmental debris. As shown in FIG. 9, beneath the outer wall are the internally located voids 4. FIG. 10 is another view of the internal voids 4 of the located beneath the outer wall 9.

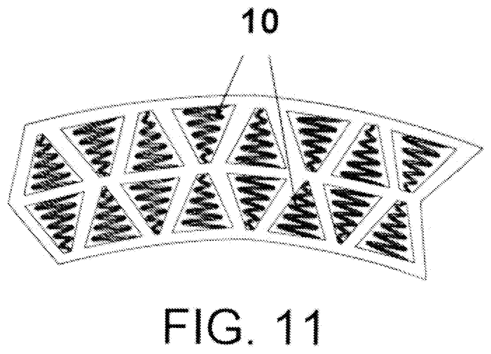

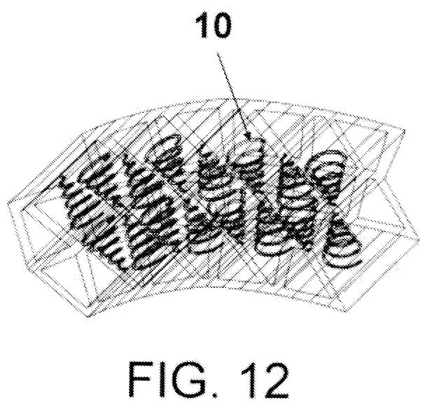

As shown in FIG. 11, the non-pneumatic structural bicycle tire of the invention may contain infill material 10 which includes, without limitation, coils, within the voids, which produced the performance of a high psi pneumatic tire. The coil infill material 10 provides a more durable compression and bounce to the structural bicycle tire of the invention. As shown in FIG. 12, the non-pneumatic structural bicycle tire of the invention includes a wire frame, which better illustrates the depth and placement of the coil infill material 10. FIG. 13 shows a section of the structural bicycle tire of the invention with recycled material blend 11 as the infill material. This blend may be added in a semi-random pattern while maintaining the durability, rebound and bounce characteristics of the structural bicycle tire.

It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

What is claimed is:

1. A non-pneumatic structural bicycle tire, comprising:
a non-pneumatic bicycle tire comprising structural members comprised of lines, arches and voids which provides properties of bounce and comfort of a pneumatic tire, while having properties durability and safety of a non-pneumatic tire.

2. The non-pneumatic structural bicycle tire of claim 1, wherein the properties of the tire are maintained whether the tire is rolled forward or backward due to the structures being positioned so that they are circumferentially symmetrical, repeating, and provide non-unidirectional compressibility.

3. The non-pneumatic structural bicycle tire of claim 1, wherein the structural members are comprised of smaller structures and internal voids.

4. The non-pneumatic structural bicycle tire bicycle tire of claim 2, wherein the structural members have varying levels of thickness or material composition to increase durability or decrease weight.

5. The non-pneumatic structural bicycle tire of claim 1, wherein the voids have varying levels of infill material to increase or decrease tire pressure and bounciness.

6. The non-pneumatic structural bicycle tire of claim 1, wherein the voids are diamond-, triangle-, V- or square-shaped.

7. The non-pneumatic structural bicycle tire of claim 1, wherein the voids contain coil infill, recyclable plastic infill semi-random extrusion or interior infill.

8. The non-pneumatic structural bicycle tire of claim 1, wherein an outer wall covers the voids.

9. The non-pneumatic structural bicycle tire of claim 2, wherein the tire is manufactured from materials selected from polymers and composites comprising thermoplastics selected from thermoplastic polyurethane (TPU), thermoplastic elastomer (TPE), thermoplastic styrenic elastomers (TPS) and thermoplastics not classified as elastomers (TPZ); polymers mixed with other compounds and fiber additives comprising carbon; plastics comprising polylactic acid (PLA) or acrylonitrile butadiene styrene (ABS); and recycled plastic material blend.

10. The non-pneumatic structural bicycle tire of claim 1, wherein air gaps are present which allow for a lower psi feel of the tire until a threshold force is applied and the air gaps are closed.
